(19) United States
(12) Patent Application Publication
(10) Pub. No.: US 2005/0131740 A1
(43) Pub. Date: Jun. 16, 2005

(54) Management tool for health care provider services

(75) Inventors: Donald S. Massenzio, Jacksonville, FL (US); Michael D. Rowley, Jacksonville, FL (US); Mark A. Gintis, Boca Raton, FL (US); Jeffrey M. Arnold, Crete, NE (US)

Correspondence Address: CARPENTER & KULAS, LLP, 1900 EMBARCADERO ROAD, SUITE 109, PALO ALTO, CA, 94303, US

(73) Assignee: GeoAge, Incorporated, Jacksonville, FL (US)

(21) Appl. No.: 11/007,618

(22) Filed: Dec. 7, 2004

Related U.S. Application Data
(60) Provisional application No. 60/528,437, filed on Dec. 10, 2003.

(51) Int. Cl. G06F 17/60; G08B 1/08; G01C 21/26; G01C 21/28; G01C 21/34; G01C 21/36; H04Q 7/00

(52) U.S. Cl. 705/2; 340/539.13; 701/213

(57) ABSTRACT

The present invention provides a system and method for controlling home health care services while improving the consistency and reliability of such services. The present invention also improves the productivity of the caregivers so that costs are reduced and care is improved. Such improvements reduce costs and provide more time with the patient. Indirect costs are also reduced because a more reliable home health care service allows a greater proportion of patients to be treated in their homes at a much lower cost than if they were still receiving inpatient services. During an emergency event, emergency responders have the ability to identify patients most at risk based on proximity to the event and based on the patient's medical condition.

### CROSS REFERENCE TO RELATED APPLICATIONS

This application claims priority from provisional U.S. patent application Ser. No. 6/528,437, filed 28 Apr. 2004 (Attorney Docket No.: 020699-1010000US) entitled SYSTEM AND METHOD FOR PLANNING, VERIFYING AND BILLING FOR HEALTH CARE PROVIDER SERVICES, the disclosure of which is incorporated herein by reference for all purposes.

### BACKGROUND OF THE INVENTION

1. Field of the Invention

This invention relates in general to an Internet based software tool and, in particular, to providing monitoring and communication services as a management tool for healthcare providers who are responsible for the well being of special-needs individuals.

2. Description of the Background Art

Special-needs refers to those individuals that have a disability or some condition or combination of conditions that renders them especially vulnerable to changes brought about by exceptional circumstances. According to the U.S. Census Bureau, 54 million Americans have a disability. This equates to approximately one fifth of the population of any given community that has some form of disability. Some communities will have a larger or smaller proportion of individuals with disabilities, but few vary markedly.

Nationwide, special-needs individuals comprise nearly four million people who require the assistance of another person for daily life activities such as getting dressed, eating and bathing. More than eight million Americans have limited vision and about 130,000 individuals are totally blind. Approximately 28 million Americans have hearing loss with about 500,000 who are completely deaf. There are about 1.5 million wheelchair users while an additional four million people require mobility aids such as canes and walkers. More than seven million people have mental retardation. Unfortunately, many special needs individuals have more than one disability. Collectively, it is clear that special-needs individuals comprise a significant proportion of the population and represent a significant problem for those responsible for caring for them.

In addition to disabilities, the special needs category also refers to individuals with acute and chronic illness. Serious chronic illnesses are a major health issue in modern society. An illness is called “chronic” if it is long lasting or lifelong. The opposite of chronic is “acute”, referring to diseases that come on quickly and often do not last long but if it does last, the disease is said to become “chronic”. In the United States, more than 90 million people have a chronic illness. The top five chronic illnesses, which are heart disease, cancer, stroke, Chronic Obstructive Pulmonary Disease (COPD), and diabetes, together cause more than two-thirds of all natural deaths in the United States.

Providing personal health care services to special-needs individuals, herein referred to as patients, in their homes, apartments or assisted living communities is a lower cost alternative to extended stays in a hospital or convalescent home. Indeed, patients who have a need for intermittent (part-time) skilled nursing care, physical or speech therapy are often better cared for outside of the hospital environment in accordance with a plan of treatment established by the patient's physician. Typically, home healthcare visits are made by a registered nurse, certified nursing assistant, physical therapist, occupational therapist, speech/language pathologist, medical social caregiver, psychiatric nurses, registered dieticians or a semi-skilled employee according to a pre-determined schedule to carry out assigned tasks in accordance with the treatment plan. These professionals are collectively referred to herein as “care givers.” Managing the delivery and quality of home health care is a primary concern of healthcare providers.

When an exceptional circumstance arises that puts patients at risk, it is often difficult to quickly assess this risk for each special needs patient and act accordingly. In the event of a power outage, for instance, it is extremely important to identify those patients that are at a significant level of risk because the loss of power. This could include those that are dependent on medical equipment to sustain their quality of life. It could also include those that have a mental impairment that might be aggravated due to the anxiety caused by the loss of power. In addition, persons that have limited mobility during normal circumstances might face impeded mobility to the point of endangerment in certain exceptional situations.

Often healthcare providers have minimal emergency management processes capable of adequately dealing with an exceptional circumstance. Often these providers use a very basic process to determine if a patient will be at-risk due to a widespread event, such as a power outage, fire, etc, or singularly at risk due to a significant change in their condition. Many providers that oversee patients utilize a manual process to ensure that patients are not at risk and to deal with at-risk circumstances.

FIG. 1 illustrates a representative current manual review process 100 that requires analysis of up to four separate reports to determine if a patient is at risk. Typically, a case manager, who may be responsible for many patients, usually conducts this manual review process. The first report 102 used in this process lists caregivers that did not show up for the scheduled home visit with a patient. Because the report is driven by collection of the patient's telephone number via automatic number identification (ANI) or caller ID, a no-show record may appear on this report if the caregiver called in from a telephone other than the telephone number listed in the database of the patient. If the caregiver does not appear on this no-show report, the next step 102 is to look at a “Daily Call Log” to ascertain whether the caregiver has indeed called in from another number. If there is no record of the caregiver call-in on this report, the case manager must further investigate if the patient is unattended.

The next report 106 that is reviewed is the “Unknown Employee List” that will show if someone other than the assigned caregiver called in from the patient's location. The final report 108 reviewed is the unknown patient report. This report is used to look for calls made from telephone numbers other than the patient. These calls may indicate an caregiver that called in from an alternate location. If the review of these reports indicates at step 110 that a true no-show situation has occurred, the case manager must call the patient at step 112 to find out if the caregiver has arrived (step 114), but has failed to call in.

If the caregiver is not present, the case manager uses a software tool at step 116, such as one called “HCOPEN,” to locate and deploy an unassigned caregiver to the patient's home at step 118. This tool allows lookup of available caregivers by zip code so that they can be quickly deployed to patients within the same area. The urgency of this deployment is based on the risk classification for the patient whose visit has been missed. The review process can end at various points 120-124 during the process but if it ends at either step 120 or 122, the case manager has wasted a significant amount of time. Another problem with this tool is that the current process only addresses the issue of missed visits and the process used to assess and act on these missed visits is dubious at best. The manual process 100 to assess the status of each visit is time consuming and often inconclusive. If the patient is at a high degree of risk due to being left unattended, the current process does little to expedite the deployment of caregivers where they are truly needed. Furthermore, the manual process relies on the inherent knowledge of the case manager regarding the potential risk associated with the patients assigned to them.

Beyond the manual process that minimally addresses missed visits, there appears to be little or no system or process that enables healthcare providers to adequately respond to other emergencies such as a wide spread emergency caused by a storm or earthquake.

For individual changes in health status, the providers rely primarily on notification from visiting caregivers, family members and others. Frequently, these status changes are not reported in a timely manner, if at all, due to time constraints and unfamiliarity with the patient's normal state.

Reliance on a manual process to notify patients of a widespread risk situation is inefficient in areas with a large population. Relying on status change reporting through informal means can also lead to the omission of important indicative information. A manual process relies on the inherent knowledge of the case manager regarding the potential risk associated with each patient. One of the greatest flaws of the manual process arises because it relies on the case manager to prioritize and determine the appropriate action for each assigned patient. If the case manager is unavailable, the patient is potentially at risk.

The manual process contains little or no system or procedure that enables healthcare providers to adequately respond to other risk situations such as a wide spread emergency caused by a storm or earthquake. In addition, there is no secure, automated audit trail to prove that action was taken by the provider to rectify a missed visit.

The prior art manual process also does not address two key emergency scenarios. The first scenario is a widespread risk condition that affects multiple special-needs patients. This type of scenario might be the result of a fire, power outage, weather condition or some other type of threat to the safety of more than one patient. The second scenario is one that affects a single patient. This type of risk condition may include a lack of response from the patient upon arrival of the caregiver, a diminishing physical or mental condition, a fall or some other similar incident that causes a change in the patient's conditions and requires a reassessment of the current treatment plan.

The home healthcare industry serves three broad categories of patients: 1) traditional post hospitalization acute care, which amounts to about 22% of Medicare's home care costs; 2) “medically complex” or seriously ill people with unstable medical conditions combined with functional impairments requiring multiple institutional admissions, which amounts to about 42.5% of Medicare home care costs; and 3) acute care services that meet the medical management needs generated by chronic illnesses, which amounts to about 35% of all Medicare home care costs. A subset of these categories comprises patients who require more than 200 visits per year. While comprising only 10% of the home care population this subset of patients account for 43% of Medicare home care costs. In order to reduce costs, health care providers are supplanting the home recovery period with prescription home care. Accordingly, home healthcare spending in the United States has increased at a rapid rate and totaled approximately $45 billion in 2001. Standalone home healthcare agencies made up approximately $33 billion of this amount. Respiratory and infusion therapy services totaled about $9 billion. With the fragmentation of the home healthcare industry, doctors, providers and payers all need to better manage each category of patient care to minimize costs while managing exposure to liability and ensuring prompt payment from the government or private insurance companies.

Healthcare industry costs have been continually increasing but reimbursement rates from the government and insurance carriers have failed to increase correspondingly. Despite well-publicized technological breakthroughs in medicine, healthcare delivery in general continues to use low technology equipment that results in low levels of productivity. Recent measures of productivity in health care delivery show a productivity decline of 2.5% per year over the past several years. Provider offices experience extremely high turnover rates among office personnel. This coupled with the relatively low level of education among these employees have combined to increase inefficiencies within the billing and financial reconciliation processes.

The low productivity in the home healthcare industry arises largely from a lack of effective communication within the healthcare delivery system. The movement of patient records among levels of care (i.e. primary, secondary, tertiary) remains largely a manual process. This manual process is susceptible to loss of data and to the creation and distribution of invalid records. Furthermore, the location and activities of attendants are not currently tracked. As a result, there is little assurance that optimal use is being made of the time of these professionals.

Thus, it is desirable to improve upon one or more of the above (and other) shortcomings in the prior art.

### BRIEF SUMMARY OF THE INVENTION

The present invention provides a system and method for controlling and tracking home health care services while improving the consistency and reliability of such services. In one embodiment of the present invention, a system and method enables a caregiver to document an assessment of each special-needs individual or patient using a field device such as a personal digital assistant (PDA), laptop or tablet computer. The field device can range from a standard touchtone telephone to a cellular telephone, PDA, laptop or tablet PC or satellite telephone. This component of the system allows the caregiver to document the physical condition of the patient and their surroundings.

The invention further comprises a database that stores information about homebound residents. This information includes identifying information, address and contact data, scheduled visit information and information regarding their relative risk such as dependence on electrical power. The level of risk recorded on the database will correspond with specific symbology usage. The database also contains coordinates for the purpose of geocoding the location of the patient. Geocoding associates an address with longitude and latitude values so that an association of the patient's address to a map location can be displayed. The data collection for the invention has two sources. The telephony component involves the collection of location and status information for individuals in remote locations. The web component allows the administrator to enter/update client and caregiver data.

The power of the Geographic Information System (GIS) and telephony applications enables the provider to monitor timely delivery of service and determine the risk status of individuals in routine or emergency situations effectively and efficiently. In emergencies, individuals that are at risk or in danger can be easily identified and be notified or have resources deployed to ensure their safety.

The present invention further provides a system and method for the monitoring and communicating with special-needs individuals or patients while improving the consistency and reliability of such services. The invention provides a process for systematically notifying a specific population of patients of an at-risk situation. The patient or a designated respondent is notified via field device using a message relaying the nature of the at-risk situation and is asked to respond by pressing pre-defined keys on their telephone device; The response is recorded and used to update visual map data with symbology corresponding to the patient's response.

Geographic Information System (GIS) technology is used to determine the location and status of the individual. GIS refers to an organized collection of computer hardware, software, geographic data, and personnel designed to efficiently capture, store, update, manipulate, analyze, and display all forms of geographically referenced information and includes the ability to geocode or address-match each location.

In practical terms, Internet based maps, allowing input decision parameters and dynamic navigation, will display symbology designating the status of the individuals. These symbols can be varied based on a set of conditional parameters to show the degree of risk associated with a missed visit. For instance, a patient needing a respiratory session that has a visit that is over two hours late may be at more risk than a patient that is waiting for a physical therapy session for a broken wrist. Additionally, differentiating special-needs individuals that require electrical power to operate medical devices from those that can cope with a power outage may be crucial in certain circumstances.

In addition to map images designating the location of at risk patients, the end user will have the ability to view reports that will give information regarding each individual location. These reports lend themselves to such performance monitoring practices as trending, totaling, etc. The levels of risk within the application can be defined. The number of risk levels is not limited and is dependant on the desires of the customer.

A narrowcast component of the system is initiated by the selection of a geographic area using the internet based map tool. The user designates an area and has the option of notifying all of the member individuals within that area of an event or at-risk situation. Further filtering of those individuals to be called is accomplished via the use of a list that can be sorted by category, name, etc. The narrowcast is then initiated and each patient is called at their pre-designated number and is notified of the risk situation via a pre-recorded message. They then have the ability to respond by pressing a key on their telephone keypad.

Many health care facilities, such as hospitals and convalescent homes, are discharging patients for recover at their homes at an earlier point in time than they would have traditionally in order to reduce costs. Unfortunately, a major problem for patients and home health care providers is the denial of payment by insurers after the care is rendered. This may occur for a number of reasons. In particular, payment is often denied because the services were not “medically reasonable,” the patient was not “homebound,” family members could have provided the care, “no improvement” would result or there was “no supervision by a skilled practitioner.” Accordingly, an embodiment of the present invention enables the caregiver to document an assessment of each patient using the field device to document the physical condition of the patient and their surroundings. One outcome of this embodiment of the invention is an assessment of potential risk during various situations.

The present invention incorporates the Administrative Simplification component of the legislation referred to as the HIPAA of 1996 as it relates to standards for electronic transactions and code sets. Compliance with this legislation, targeted for Oct. 16, 2003, met with widespread hardship and inability to comply among smaller provider offices. Costly software upgrades and complex regulations have led to a relaxation of enforcement of this legislation to avoid massive increases in paper claim volumes. The Privacy and Security component of the HIPAA legislation took effect in April of 2003. This component has both a procedural and technological aspects that is designed to secure protected health information (PHI) so that it cannot be used for purposes outside the performance of health care services. The technical aspect of this legislation covers the data security and encryption that is enforced for electronic transactions. An embodiment of the present invention complies with these requirements and provides small health care providers with a system and method that can be easily updated to comply with future legislative changes.

In another embodiment of the present invention, caregivers, the patient or other individuals are given the opportunity to initiate the process whereby a treatment plan is modified to meet the patient's changed condition. To activate this process, a call is made to a designated telephone number, referred to as the SafeStatus number. SafeStatus is a trademark of GeoAge Corporation, the assignee of the present application. In response to the telephone request an electronic notice is provided to the responsible agency. Importantly, the call to the designated telephone number and the electronic notice to the agency generate an important audit trail that can be used manage resources and to minimize the risk of litigation. In response to the notice, the agency is able to identify the location of the patient, make a risk assessment and deploy caregivers or other appropriate personnel where needed. Further, the healthcare provider's exposure to liability is minimized because of the audit trail.

In the event of a widespread geographic emergency, multiple patients within the affected area are selected using a web tool and a broadcast message is communicated to each selected patient via an automated callout. The initial selection of patients is made by either a graphical selection of an area on a displayed map or, alternatively with a software filter in the reporting system. Patient selection is refined by selecting or deselecting individual patients within the report view.

Once the sub-selection of patients is complete, the broadcast message is sent to the selected patients. This is an automatic dial to the telephone numbers stored within the patient database for each patient. If the patient or some other individual answers the telephone, they will have the opportunity to respond to the recorded message with a status code equating to either “Safe” or “Not Safe—Need Assistance.” If the call is answered by an answering machine, this is considered a non-response and the map is updated accordingly. If a busy signal is encountered, the call will be retried a pre-determined number of times before it is considered a non-response.

The foregoing and additional features and advantages of this invention will become apparent from the detailed description and review of-the associated drawing figures that follow.

### BRIEF DESCRIPTION OF THE DRAWINGS

FIG. 1 shows one prior art system for managing the deployment of caregivers in a health care system.

FIG. 2 shows an embodiment of the architecture of a healthcare control system in accordance with the present invention.

FIG. 3 is a block diagram of the healthcare control system in accordance with the present invention.

FIG. 4 is a block diagram of the operational modules for operation of the server in accordance with an embodiment of the present invention;

FIG. 5 is a block diagram of the operational modules for operation of the field unit in accordance with an embodiment of the present invention.

FIG. 6 illustrates a flow diagram for operation of the control system in accordance with an embodiment of the present invention.

FIG. 7 illustrates a flow diagram for broadcasting a telephone query in accordance with an embodiment of the present invention.

FIG. 8 illustrates a flow diagram for an caregiver to declare an emergency event in accordance with an embodiment of the present invention.

FIG. 9 illustrates a notification message in accordance with an embodiment of the present invention.

FIG. 10 illustrates a map report in accordance with an embodiment of the present invention.

FIG. 11 illustrates a-map report of FIG. 10 with a selected region in accordance with an embodiment of the present invention.

FIG. 12 illustrates a drill-down map report of the selected region in FIG. 11 in accordance with an embodiment of the present invention.

FIG. 13 illustrates a broadcast report in accordance with an embodiment of the present invention.

FIG. 14 illustrates a drill-down map report of the selected region in FIG. 12 in accordance with an embodiment of the present invention.

FIG. 15 illustrates a report summary of the region selected in FIG. 11 in accordance with an embodiment of the present invention.

FIG. 16 illustrates a detailed report for a patient selected from the report in FIG. 15 in accordance with an embodiment of the present invention.

FIG. 17 illustrates a drill-down map report of the selected region in FIG. 14 in accordance with an embodiment of the present invention.

FIG. 18 illustrates a drill-down map report of the selected region in FIG. 17 in accordance with an embodiment of the present invention.

FIG. 19 illustrates a report summary of the region to assist emergency responders in locating at-risk patients in accordance with an embodiment of the present invention.

FIG. 20 illustrates a detailed report for a patient selected from the report in FIG. 19 in accordance with an embodiment of the present invention.

FIG. 21 illustrates a representative embodiment of a system for updating information in accordance with an embodiment of the present invention.

FIG. 22 illustrates an embodiment of a database structure in accordance with an embodiment of the present invention.

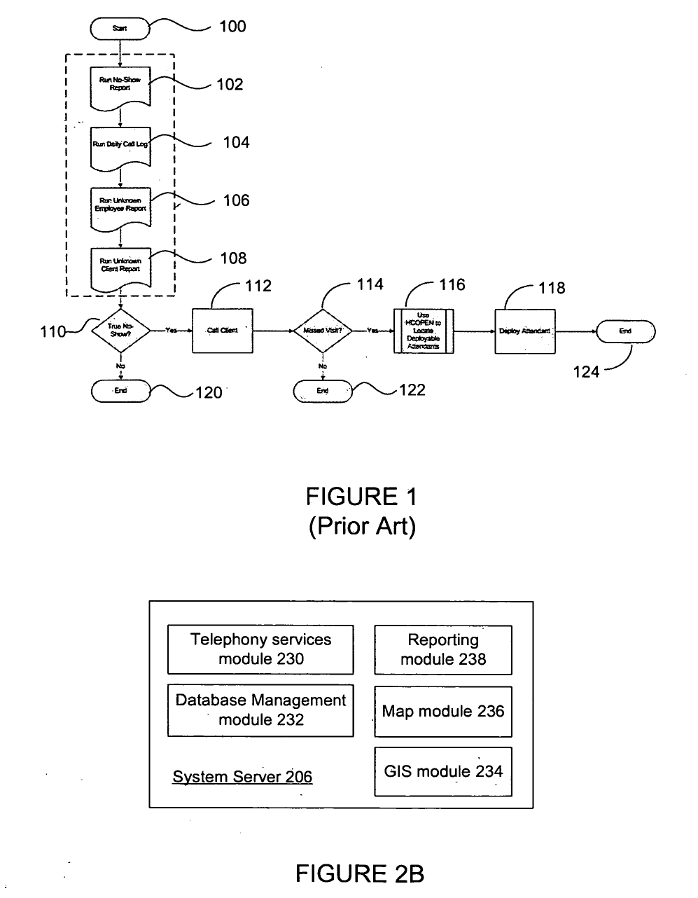

### DETAILED DESCRIPTION OF THE INVENTION

In the description herein for embodiments of the present invention, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

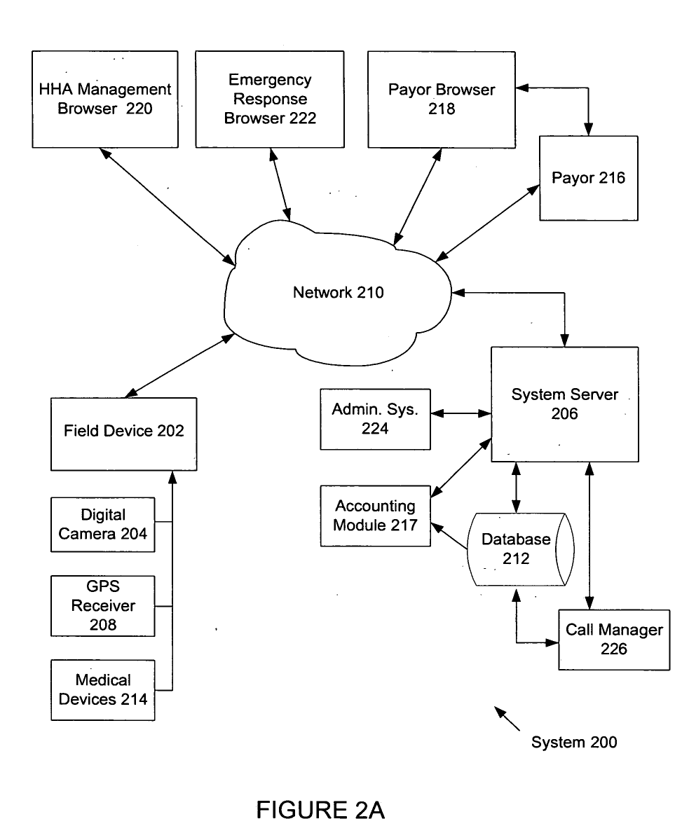

Referring now to the drawings more particularly by reference numbers, a simplified embodiment of a representative healthcare control system 200 for supporting an caregiver is shown in FIGS. 2A and 2B. It is to be understood that a system capable of meeting the requirements of the present invention will depend on many factors so the actual configuration of system 200 may vary depending on the specific capabilities required for a given application. As such, the system illustrated in FIGS. 2A and 2B are exemplary in nature. One example of the architectural infrastructure of a system capable of supporting a large number of field devices was disclosed in U.S. Pat. No. 6,574,561 (the '561 patent). The '561 patent issued on Jun. 3, 2003 to Alexander, et al. and assigned to the University of North Florida of Jacksonville, Fla. The assignee of the present invention, GeoAge, Inc. of Jacksonville, Fla., has licensed the '561patent on an exclusive basis. The disclosure of the '561 patent is incorporated herein by reference.

Control system 200 adapts the architecture of an emergency management system to the automated gathering of patient information at specific geographical locations at specific times via a field device. Control system 200 tracks and verifies the entire process of providing home health care services from identification of need through delivery of service, billing and payment. Services are provided to patients in their homes by a registered nurse, certified nursing assistant, physical therapist, occupational therapist, speech/language pathologist, medical social caregiver, psychiatric nurses, registered dieticians or home health aide (collectively caregivers) according to a pre-determined schedule. These caregivers, employed by the health care providers, are often inadequately compensated, which results in high turnover in professions that are already facing a severe shortage of qualified workers. Even with high turnover, however, healthcare providers are able to maintain continuity and consistency of service with the present invention because new caregivers are provided with the patient's location, history, current condition and suggested course of care. If the caregiver determines that new or additional services are required, the caregiver is able to document the need for such care and to obtain approval for such care in real time. In this manner, the health care service provider improves service to the patient while minimizing its liability that might arise from failure to provide services and maximizing the likelihood that the private insurance company or government will reimburse the provider for providing the care.

Specifically, a field device 202 is assigned to each caregiver. Using the field device 202 instructions regarding a patient care plan can be displayed and the caregiver can enter information regarding the patient. Preferably, the information is in response to a list of questions to which a short answer can be easily provided by selecting a key on the field device, or by using a stylus to select a ‘check box’ on a touch screen thereby eliminating the need for a keyboard. Field device 202 may also include means to record a voice file containing caregiver observations regarding the patient and attach the recording to an electronic mail message or to transmit the recording as a file. Field device 202 includes an integrated digital camera 204 to generate digital photos of the patient that can be stored in field device 202 for subsequent uploading to a management server 206 or transmitted to server 206 in real time. Preferably, field device 202 is a cellular telephone, a personal digital assistant (PDA) such as the commercially available Blackberry PDA telephone, a satellite telephone, or a small portable computer or other form of portable electronic equipment.

Field device 202 also includes means for determining position of the caregiver. For example, a Global Positioning Satellite (GPS) receiver 208 may be provided to each caregiver for recording and assigning space-time coordinates as information from the patient is gathered. Receiver 208 may be integrated as part of field device or a separate device that is electronically linked to field device 202. The information and space-time coordinates are periodically transmitted by field device 202 to server 206 over a communication network 210.

Other medical devices 214, such as a digital scale, blood pressure, glucose monitor, thermometer or other medical device that provides a digital measurement may be coupled to field device 202 for transmission to server 206.

Because clinical data and other patient information (collectively protected health information or PHI) is transmitted over wireless modems to server 206, control system 200 includes all of the instructions and protocols necessary to transmit encrypted PHI over each link. Further, caregivers can electronically submit claims directly to server 206 but the encryption prohibits the use of PHI for purposes outside the performance of health care services or the processing of payments for those services.

Browsers 220 and 222 enable other authorities to access certain portions of the information stored in database 212. For example, a government agency responsible for oversight of health and human services may access all or portions of database 212 through web browser 220 and emergency response agencies may access all or portions of database 212 through web browser 222. With the availability of the Internet, other agencies may be quickly granted access to selected information through any commercially available web browser.

Network 210 may comprise a wireless Internet connection, pager network, cellular telephone network or-the public switched telephone network. Upon receipt of the PHI, server 206 integrates the newly acquired PHI into a patient care database 212 such that the database provides information showing the current and historical conditions of the patient, a historical record of the care provided and the care plan approved by payer 216. Other information may be included in patient care database 212. In some applications, it may be preferable to structure database 212 as a relational database such that database 212 comprises a plurality of linked smaller dedicated databases.

The invention consists of a database that stores information about homebound residents. This information includes identifying information, address and contact data, scheduled visit information and information regarding their relative risk such as dependence on electrical power. The level of risk recorded on the database will correspond with specific symbology usage. The database also contains coordinates for the purpose of geocoding the location of the patient. Geocoding associates an address with longitude and latitude values so that an association of the patient's address to a map location can be displayed. The data collection for the invention has two sources. The telephony component involves the collection of location and status information for individuals in remote locations. The web component allows the administrator to enter/update client and caregiver data.

Database 212 may comprises a plurality of linked databases such as a PHI database that contains patient specific data and information. In addition, the PHI database may contain an indication or ranking of the patient for one or more types of emergency conditions. To illustrate, if certain patients require electricity to operate life support equipment, the PHI database may provide a high ranking to such patients so that in the event of a power outage affecting one or more of such patients, assistance is timely dispatched.

Database 212 may further comprises a billing rate database includes the billing rates for each caregiver retained by the health care provider as well as an indication as to whether an caregiver is authorized to provide service to a particular patient. Database 212 may include a database that stores approved time or charge authorization that each payer has agreed to pay for specified procedures. Alternatively, this information may be obtained directly from a database maintained by a payer 216 so that current authorizations are used in calculating a statement. Payer 216 may be an insurance company or government agency responsible for paying for the service provided by the caregiver or for reviewing the service to ensure that service is consistent with the care plan.

Database 212 stores information about each homebound resident that includes patient specific information, such as each patient's name and ID number, address and contact data such as one or more telephone numbers, scheduled visit information and information regarding their relative risk such as dependence on electrical power. The level of risk recorded on the database will correspond with specific symbology usage. The database 212 contains coordinates for the purpose of geocoding the location of the patient. For example, the latitude and longitude or other location coordinates corresponding to the patient's address is geocoded in database 212. Geocoding associates an address with longitude and latitude values so that the patient's address can be displayed on a map. The data collection for the invention has two sources. The telephony component involves the collection of location and status information for individuals in remote locations. Information generated by the field device is used to indicate the commencement of a visit would contain selected Status Codes and response results. The web component allows the administrator to enter/update client and caregiver data.

Database 212 is used for reporting purposes. System 200 can utilize connected field units such as PDAs, laptops, tablet PCs, cellular telephone or a telephone based system to receive information from the field and generate real time reports. System 200 reports the commencement of a visit including the time and date that the visit began.

This invention further utilizes GIS technology with geocoded location data to produce a graphical representation of each location, probably in the form of a localized map. This graphical representation is assigned a meaningful color (such as red, yellow and green) and/or shape to indicate the level of risk or status of the patient. The status is linked to the relationship with other user-defined parameters. The level of risk can be updated either by the commencement of a visit or through manual intervention by an authorized user. The change in status is recorded and fully auditable with database 212.

An accounting software program 217, executing on server 206 or other computer platform, uses the information in database 212 to generate a billing statement for electronic transmission to payer 216 over the communication network 210. The distribution process may further include the process of making information in database 212 available to payer 216 on demand through a web browser interface 218.

The PHI loaded or transferred to field device 202 at the start of the day includes the name, address and routing instructions for each patient. The PHI also includes specific instructions on the service to be provided, including (OASIS) codes, patient medical history (to the extent deemed appropriate by the agency) and detailed guidance on problem diagnosis and response.

Referring now to FIG. 2B, server 206 is shown in greater detail. Server 206 may include or access a plurality of software modules that are dedicated to performing certain tasks. These modules may be resident on server 206 or may be distributed among other computer processing systems (not shown). These other systems may be accessed over a local network or other computer network to allow distributed processing of a specific task or function.

A telephony services module 230 collects information regarding the status of homebound individuals and updates database 212 when status conditions change. Module 230 interfaces with call manager 226 to facilitate the initiation of the narrowcast telephone calls process described below.

A database management module 232 controls access to database 212 from field device 202, administrative console 224, accounting module 217 or call manager 226. Module 232 manages content format and validity and maintains database 212 as specific tables in the relational database are updated. Module 232 also manages the interface with field collection devices 202.

A GIS module 234 matches the patient addresses with geocoded information. More specifically, module 234 determines the appropriate GIS geocoded data to associated with each patient's address so that map module 236 can place the GIS/geocoded data into a visual interface for mapping purposes. Module 234 also associates selected geographic areas with groupings of individuals and maintains the association in database 212.

A reporting module 236 summarizes collected data for trending, performance management and deployment purposes.

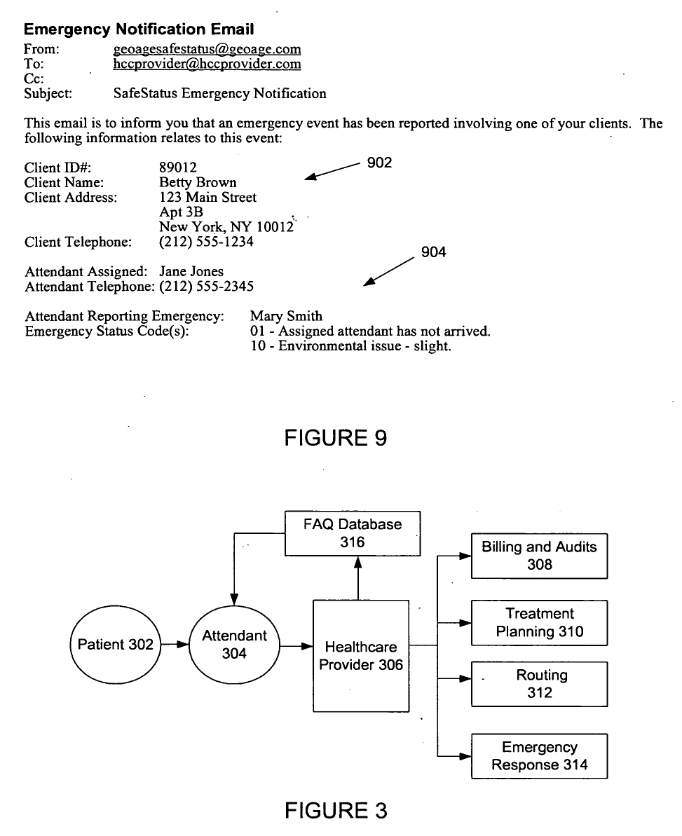

FIG. 3 illustrates an overview of control system 200. When a patient 302 requires home care, a caregiver 304 is assigned to provide the care and to report on their care activities. The PHI generated by caregiver 304 is transmitted to healthcare provider 306 who maintains or has maintained the PHI in a secure encrypted database. Provider 306 may be a private entity that contracts with a state or federal agency to provide home care to patients 302. In some instances, Provider 306 may manage system 200 but in the preferred-embodiment, system 200 comprises a web based application hosted by an Application Service Provider (ASP) who is responsible for locating and maintaining one or more servers, distributed databases (primary and backup or mirrored databases) and other similar services.

With the information captured from caregiver 304, provider 306 creates a real-time verifiable billing record and audit trail with billing and audit module 308. Provider 306 also ensures that the treatment plan is up to date and adequate by correlating in real time the treatment provided with allowed treatments with treatment planning module 310. Provider 306 can reduce the amount of time it takes case managers to verify patients are being attended to on schedule and in the event of missed appointment quickly verify and resolve the problem with routing and patient tracking module 312. Module 312 can be used on a day to day basis to track caregivers in the field or in the event of an emergency used by emergency responders such as police, fire or paramedics. Provider or other governmental agencies can quickly identify at-risk patients in the event of a local or regional emergency using the emergency response modules 314. The FAQ Database 316 can be accessed by caregivers to gain relevant information to assist them in properly performing their duties.

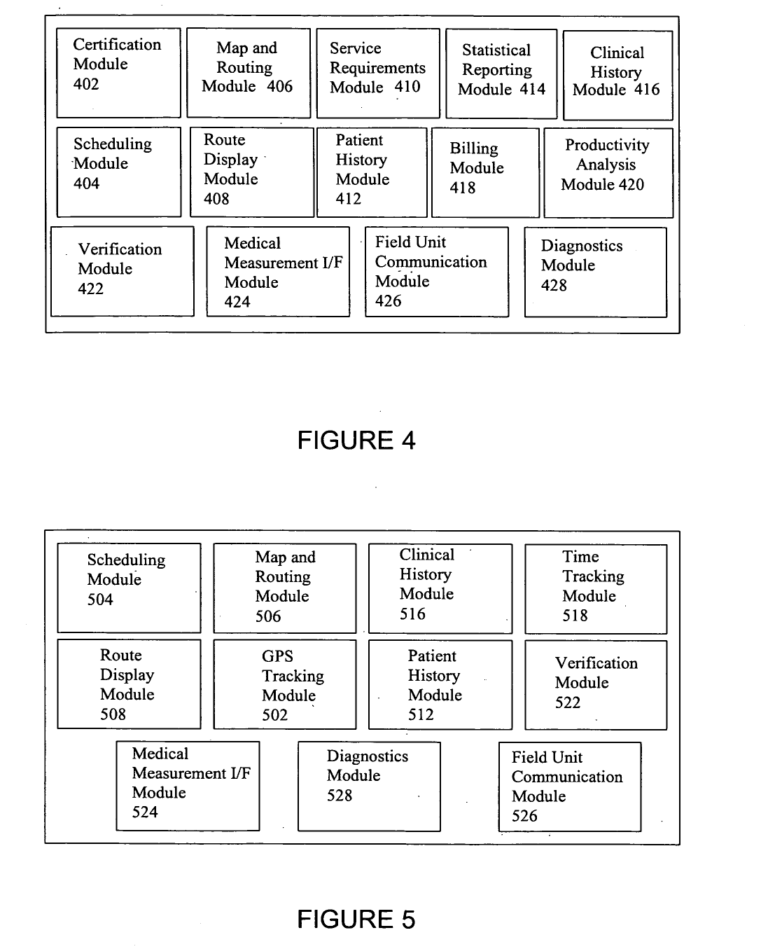

FIG. 4 illustrates the various modules that may be resident on server 206 or distributed across several servers or other computer systems coupled to server 206. These modules include a certification module 402 that determines whether a patient is entitled to receive home health care. Once a visit has been certified either through prescription or through an eligibility and benefits check with the patient's insurance carrier, the patient is entered into the scheduling system. Certification module 402 identifies caregivers to be assigned to the patient.

A scheduling module 404 that schedules the appropriate caregiver to visit each patient. Scheduling module 404 resides on server 206 and includes or accesses a geographic information system (GIS) database and mapping tools to facilitate the efficient routing of caregivers identified by certification module 402 to the patient location. Scheduling module 404 includes a list of each caregiver's patient allotment that is displayed in the form of a graphically displayed map. The map or maps for each caregiver is transferred to field device 202 so that the caregiver may display the map during the course of their work period. The map contains symbols representing the location of their patients. By clicking a symbol, the scheduler can view the exact service requirements of that patient, along with their relevant medical history.

A map and routing module 406, preferably resident on server 206 or other coupled to server, determines the best route for each caregiver to travel from one patient to the next patient. Map and routing module 406 also includes routines for the management of emergencies such as power outages, bad weather, evacuations or suggests alternative routes when traffic congestion would make the original route undesirable.

A route display module 408, resident on either field device 202 or server 206, incorporates the GIS output into a formatted display on field device 202 showing the caregiver the map for traveling from one patient to the next. If module 408 is resident on the server, the route information is electronically transmitted to field device 202 for display. Modules 406, 404 and 408 cooperate to enable the health care provider and government agencies to identify patients at risk in the event of an emergency. Based on their location and special needs of the patient, health care provider can use administration system 224 to send specific instructions to caregivers as to how to deal with each patient and to expedite the deployment of necessary resources such as police, fire rescue or ambulance should the need arise. The information in database 212 is also available for distribution to emergency response authorities, via browser 222, that may need to know the location of elderly or incapacitated individuals in the event of an emergency such as, by way of example, a hurricane, fire, flood, heat waves, cold spells or a power outage that affects certain patients.

A service requirements module 410, preferably resident on server 206 or other coupled to server, defines the service to be provided to each patient by a caregiver. This information may be sent once the caregiver has arrived at the patient's location or it may be transferred to field device 202 at the start of the caregiver's work period.

Server 206 or another coupled server further includes additional modules that are accessed to ensure proper patient care. A patient history module 412 provides the caregiver with background information for each patient should the caregiver require a review of what has been done in the past. Module 412 may provide a summary, or high level, report with the ability to drill down on any specific subject. A statistical reporting module 414 provides management reports so that doctors and supervisors can monitor the results of patient treatment. A clinical history module 416 is a review tool that assists the caregiver and their supervisor in making diagnosis of conditions that may change over time and then planning an effective course of treatment. A billing module 418 provides billing statements to payer 216. A productivity analysis module 420 generates reports relating to the costs for providing care to each patient and correlates the services with the payment received from payer 216. A verification module 422 verifies the caregiver provided the services at the patient's location by matching GPS coordinates or location with service records. A medical measurement module 424 receives measurements made in the field by the caregiver and saves such records in database 212 to support the billings statement. A field unit communication module 426 maintains or establishes a communication link with each caregiver while in the field. A diagnostic module 428 monitors the service requirements module 410, verification module 422, the medical measurement module 424 to provide an estimate that the service is necessary and will reimbursed by payer 216 or is otherwise medically necessary.

FIG. 5 illustrates the various program modules resident on field device 202 that is carried by the caregiver while out in the field visiting the patients. These modules include a GPS tracking module 502 that acquires the caregiver's position from GPS receiver 208. A scheduling module 504 provides the caregiver with a display of each patient to be visited and the type of care to be provided. A map and routing module 506 includes a portion of a GIS database so that the caregiver is provided with the optimal route to reach the next patient. The GIS database may be updated while the caregiver is out in the field if necessary. Module 506 may change the route in response to changes in traffic, weather or other factors that can negatively impact the transit time of caregiver to the patient. Such factors-are preferably received from server 206 but could also be provided by radio link to third party providers of weather and traffic information. A route display module 508 graphically displays the optimal route for the caregiver to take to reach the next patient, the module may also include text or audio route instructions. A patient history module 512 includes patient specific information that may be accessed by the caregiver during patient assessment. A clinical history module 516 provides the caregiver with the patient history in an SQL database. A time tracking module 518 monitors the caregiver's time at the patient's location. Preferably, when the caregiver arrives at the patient's location, the GPS receiver 208 generates an indication of arrival and when the caregiver leaves the location, receiver 208 generates an indication of departure. Module 518 combines the indications of arrival and departure to define a treatment window during which the PHI was acquired. A verification module 522 compares the time spent at the patient's location with the services to be provided using medical metrics based on community standards of care. A medical measurement module 524 receives measurements from digital medical instrumentation. A server communication module 526 maintains or establishes a communication link with server 206. A diagnostic module 528 monitors the service requirements module 510, verification module 522, the medical measurement module 524 to provide an estimate that the service is necessary and will be reimbursed by the payer.

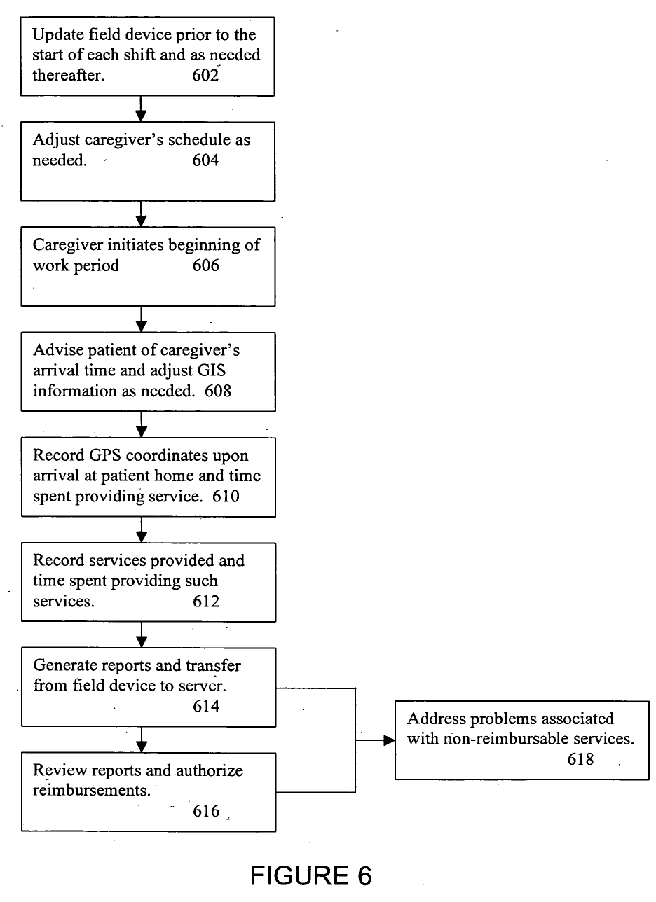

FIG. 6 illustrates an exemplary flow diagram of the operation of a field device, which is provided to each caregiver. Once a patient's records are loaded or transferred to server 206 and payer 216 approves a treatment plan, caregivers are assigned to the patient. At the start of each work period or at other selected times, field device 202 establishes a link with server 206 and receives the information that defines the caregiver's tasks as indicated at 602.

As indicated at 604, the caregiver can initiate the communication link or server 206 can automatically establish it to reflect changing conditions during the course of the work period. For example, server 206 may be connected to regional hospitals to monitor admissions lists and to scan such lists for patients on the caregiver's schedule. Thus, if a patient on the caregiver's task list is admitted to a hospital, the caregiver is advised of this change in the scheduled list of patients to be visited that day and their route is automatically recalculated. Further, the patient can also call in and reschedule the visit should the patient need to visit the doctor or some other event occurs that makes it inconvenient for the patient to be available for the caregiver's appointment. Thus, the caregiver's schedule is automatically adjusted so that time is not wasted on attempting to complete a scheduled appointment when the patient is unavailable.

When the caregiver begins their work period, as indicated at 606, they register using field device 202 to communicate with server 206 and proceed to the first patient's location using GIS information displayed by field device 202.

As indicated at 608, server 206 may optionally calculate an anticipated arrival time and advise the patient of the caregiver's arrival by delivery of an automated telephone message—for example: “Good morning, your caregiver has asked that we advise you that she expects to be at your home in about ten minutes.” This feature is referred to as an automated push telephone call. To ensure that the caregiver is on time, field device 202 assists the caregiver in locating the patient's home using the GIS information. The GIS information may be updated either before the start of each visit or intermittently throughout the day to reflect road closures or traffic congestion so that the transit time is minimized.

Upon arrival at the patient's home, as indicated at 610, the caregiver obtains a GPS signal that the system recognizes as the start of the visit. The GPS coordinates are recorded together with a time stamp in field device 202 and will delineate the data to be collected for this patient. The field device displays one or more forms or checklists for the visit and provides access to detailed guidance that relates to each of the activities. In the preferred embodiment, the present invention utilizes a forms-based checklist that lists the patient's anticipated care regimen. The disclosed information must not exceed what is necessary for the scheduled services. The caregiver is presented with a series of relevant graphical forms or panels to facilitate the collection of data from the visit that will vary depending on the patient or the type of task to be performed. The caregiver then proceeds to provide the necessary care using the forms or checklists displayed on the field device as a guide. The caregiver may enter information to annotate the data collected by instruments. The'se forms or checklists comprise the electronic equivalent of the prior art patient file printed out in paper form.

The caregiver can use digital camera 204 to capture photographic evidence of any problem noted with the patient and the photo appended to the file. Other medical devices may provide data relating to the patient's temperature, blood pressure, respiratory measurements or other specialized medical measurements. When the caregiver considers the visit complete, the system checks that all necessary steps have been recorded and correctly coded. To complete the visit, the caregiver obtains a second GPS signal that the system recognizes as the conclusion of the visit. If required, and the field device has been equipped with a wireless modem or cellular connection, the caregiver can transmit the details of the complete visit to the application server before proceeding to the next patient. Otherwise, the PHI is retained by field device for transfer to server 206 at the conclusion of the work shift. Thus, at the end of the day, the caregiver uploads the shift's activities to the application server using a connection to the Internet or an intermediate upload to a laptop or desktop computer with Internet connectivity. Data transfer can also be done by physically taking the field device to a location such as the health care provider's office from which the data can be transferred directly to the application server. In addition, the reports provide a secure, automated audit trail to prove that the healthcare provider took timely and proper action.

Given the estimated time to be spent providing the services performed for each patient, an administrator at console 224 can monitor whether the services will be fully reimbursed or are medically necessary. Further, system 200 can determine whether the caregiver is spending too much time on non-reimbursable services. During the course of the home visit, diagnostic module 528 monitors the service requirements module 510, verification module 522, the medical measurement module 524 and can flag a supervisor that review the patient's treatment plan to determine whether the service is medically necessary or will be reimbursed by the payer.

As indicated at 612, upon completion of the services, the caregiver adds their annotation regarding the visit to patient's file and closes the patient's file. When the caregiver leaves the location, the change in the GPS coordinate are noted together with the time. The PHI is appended to a report form that includes a summary of the visit—that is, the services performed (including the OASIS codes) and general observations. If the caregiver recommends that the patient schedule an appointment with their physician, this can be done automatically and a paper document can be printed and provided by the caregiver to the patient with the time and location of the appointment. The PHI is also transmitted to the physician's office together with the caregiver's full report on the patient.

As indicated at.614, the caregiver can transfer information from the field device to the provider's server at intermittent intervals throughout the work shift or at the end of the work shift. Rather than waiting for a daily report to be transcribed or accumulating reports until the end of the month before submitting to payer, system 200 accumulates the daily reports from each caregiver and generates an itemized invoice that is submitted to the payer on a daily, weekly, monthly or an agreed upon basis. Thus, if the payer intends to decline reimbursement, the provider can require a prompt notice of the declined transactions. Upon receipt of the daily invoice, the payer reviews the invoice for errors or omissions. Further, as indicated at 616, the payer can review the invoice on a historical perspective for other patients having the same medical condition to determine if the care is within acceptable guidelines. If problems with a particular caregiver are noted, the payer can flag the problems to allow the provider the opportunity to correct the problem before incurring large non-reimbursable charges, as indicated at 518.

In another embodiment, the present invention further provides a method for managing patients affected by a widespread geographic emergency. When an emergency occurs, health care providers and responsible government agencies must have a comprehensive emergency management protocol to deal with patients that are at risk due to physical, mental and environmental situations that may compromise their safety. In this type of situation, a large numbers of patients may be at risk, which may necessitate the quick and efficient assessment and resolution of any life threatening conditions, including coordination with authorities such as fire, police, ambulance or other emergency personnel. In order to respond to the emergency in a timely fashion, the present invention mines the data in database 212 to identify patients at risk.

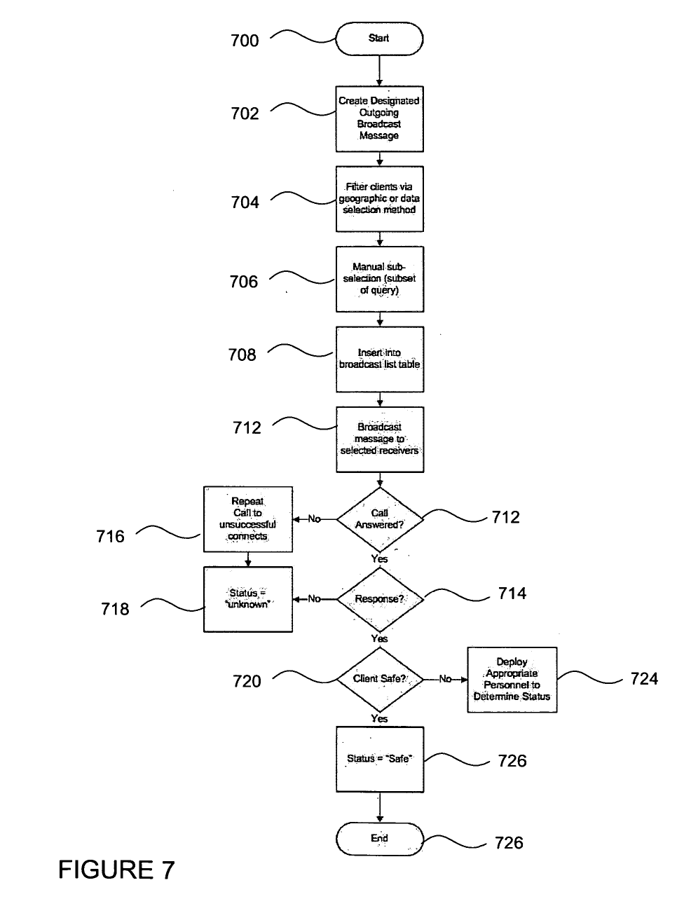

When an emergency occurs, the mining process 700 begins by defining an alert message that is broadcast to patients in the geographic area affected by the emergency. Process 700 is shown in FIG. 7. In the first step, an outgoing message is created or selected from one of several pre-defined messages as indicated at step 702. Each message includes one or more response queries that are to be answered by the patient. Database 212 is then accessed and patients matching a selected criteria are identified. The identification criteria may be based on geographic location or by other data. For example, a multiple tier selection process may be defined whereby a patient requiring electricity will be contacted in the event of a power outage but a patient that is receiving physical therapy would not even though both patients are in the affected geographical area. Further, as indicated at step 706, patients matching the identification criteria may be deselected upon manual review. As indicated at step 708, the telephone number or numbers for the selected patients are transferred to a broadcast list table. As indicated at step 710, this table is then accessed by a commercial available call manager program to broadcast the message to the selected telephone numbers.

If the telephone call is answered, as indicated at step 712, the process proceeds to determine if the patient has responded to the query, as indicated at step 714. To illustrate, if the patient answers the call, the message informs the patient of the reason for the call and inquires as to whether the patient is affected by the emergency. If the call is not answered at step 712, several additional attempts to reach the patient are made as indicated at 716. Such additional attempts may include trying different telephone numbers associated with the patient. If there is no answer, if a busy signal is encountered or if the call is answered by an answering machine, the at-risk condition continues to be indicated for the patient. If either the calls are not answered or if there was no response to the query, the patient's status is set to an “unknown” status as indicated at step 718.

Patients (or caregivers, if present) that answer the telephone during this broadcast message are prompted to indicate their status via a keyed selection on the telephone. Specifically, the patient will have the opportunity to respond to the broadcast message with a status code equating to either “Safe” or “Not Safe—Need Assistance”. The process proceeds to step 720 where the response is analyzed to determine if the patient is safe or requires assistance. If the patient indicates that they are safe, the database 212 is updated with that information as indicated at step 722. If however, as indicated at step 724, the patient indicates that they are not safe or require assistance, the process deploys the appropriate personnel such as police, paramedics or other emergency response personnel to determine the patient's status and to render aid. The process returns control to the calling program at step 726. This process is defined so that multiple patients and caregivers can be notified of an emergency situation via a broadcast message.

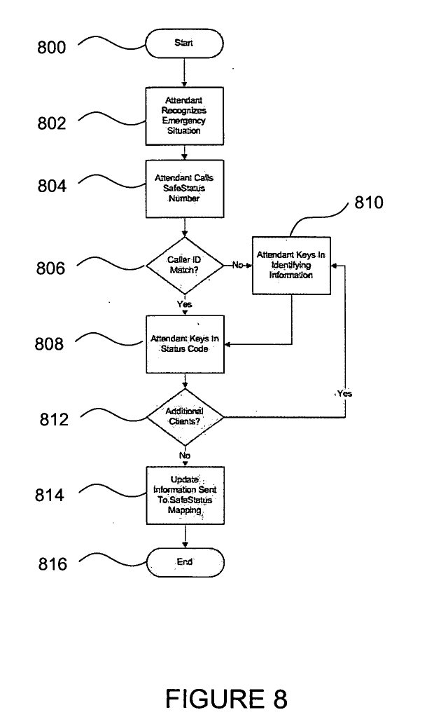

If the emergency or risk condition is restricted to just one or a limited number of patients, the process flow 800 shown in FIG. 8 is activated. This type of risk condition may include a lack of response from the patient upon arrival of the caregiver, a diminishing physical or mental condition, a fall or some other incident that-affects one patient or a missed caregiver visit. As indicated at steps 802 and 804, when the caregiver recognizes that a risk condition is present, database 212 is updated by a telephone call to a designated telephone number referred to herein as the SafeStatus number. (SafeStatus is a trademark of GeoAge, the assignee of the present invention). The call can be made by an caregiver, a third-party such as a family member, or by the patient using the telephone associated with the patient so that a caller-ID program can automatically determine the address of the caller as indicated at step 806. If valid caller ID information is not be available, the caregiver may need to call from an alternative telephone during the emergency. In the event that this occurs, there needs to be a process for the caregiver to enter information identifying themselves and the patient for which they are reporting the status on. Preferably, an identification number to is assigned to both the caregiver and the patient and these identification numbers are used to identify the caller. If a different phone is used, additional identifying information is also required to ascertain the location of the patient as indicated at step 810. The calling party may use or select from a list of status codes that may be entered during the call as indicated at step 808 for the patient or if other patients are affected, as indicated at step 812, process flow returns to steps 810 and 808. The status codes indicate several factors that may affect a patient. For example, one code indicates that an caregiver has not arrived within a scheduled time-period thereby putting the patient at risk. The status code may also indicate changes in the patient's physical and mental state as well as environmental situations that might endanger or agitate the patient. Table 1 sets forth a representative listing of possible status codes.

TABLE 1

| Code | Meaning | Type | Action |
|---|---|---|---|
| 01 | Assigned caregiver has not arrived within | Visit | Case Manager takes |
| | designated time-period | | appropriate action. |
| 02 | Assigned caregiver has arrived | Visit | Incident Closed |
| 03 | Substitute caregiver has arrived | Visit | Incident Closed |
| 04 | Patient does not answer door | Physical | Caregiver notifies |
| | | | appropriate person. |
| 05 | Patient physical condition has diminished | Physical | Agency Case Manager |
| | | | and Nurse notified. |
| 06 | Patient mental condition has diminished | Mental | Agency Case Manager |
| | | | and Nurse notified. |
| 07 | Patient taken to hospital | Transfer | Agency Case Manager |
| | | | and Nurse notified. |
| 08 | Environmental issue | Environmental | Agency Case Manager |
| | | | and Nurse notified. |

The processing path defined by the repetition of steps 810 and 808 helps to facilitate patient status checks in a single geographical area during some type of environmental event. It also allows those caregivers with mutual and cluster care scenarios (such as an assisted living home facility or an area with a high density of the elderly) to enter information for multiple patients.

In response to the information received, database 212 is updated as indicated at step 814 and the process terminates at step 816. As an alternative, the patient may call an alternate, passive telephone number that has an operator so there will be no need to enter a status code. With the database update, an alert is generated to notify the appropriate authorities. One such alert is illustrated in FIG. 9 where an emergency notification email is shown for a patient identified at 902. In the illustrated example, the cause of the emergency is that the assigned caregiver has not arrived as scheduled as indicated at 904. The alert can also be sent to one or more pagers or cellular telephones.

The present invention classifies patients based on a color-coded system using a plurality of colors to graphically indicate the severity of a patient's condition. The federal government's Department of Health (DOH) has dictated standards that must be followed in classifying these patients. To illustrate, patients that are classified as red are those that must require immediate service or assistance in the event of an emergency. These patients also may require transfer to a skilled nursing facility. They are classified as patients that, if they are without service, could be in mortal danger. Conditions that are typical of patients include: the need for dialysis more than three visits weekly; they are Immobilized or paralyzed; they are classified as unstable cardiac-obese; they suffer from severe Alzheimer's disease or dementia; or they are severely mentally disturbed or retarded.

Yellow coded patients require some limited and/or special care facility or shelter and are characterized by: the need for oxygen (with notification to the electric utility if they are on compressed air); chronic respiratory conditions; mental handicaps that are not violent; physical handicaps (non-ventilator) with special needs; a need for assistance with Activities of Daily Living (ADL) such as assistance in going to the toilet or with eating; a need for assistance with vital signs and medications; catheter maintenance; or unstable diabetes.

Patients that require services provided by a home caregiver that are neither a red or yellow coded patient fall into the green category. Green coded patients are those that typically do not need constant care and have some degree of independence.

The present invention applies the same color-coding of patients when geographic or environmental emergencies occur that make it necessary for the health care provider to identify all patients at risk within a given area. The health care provider color-codes their patients to prioritize or filter those that need immediate attention in an emergency.

Once patients are color coded, interactive mapping features of the present invention identify and locate at-risk patients. The population of a map will result from the geo-coding of the patient addresses. The geo-coding is periodically updated based on the PHI in database 212 and specifically updates to the map will result from a declaration of an emergency in a geographic area or through calls to the SafeStatus telephone number.

The display of maps is interactive in a drill-down fashion beginning with a regional or city level map. The mapping tool supports drill down ability to a particular block or street address. Sharing of data between agencies is accommodated during an emergency by authorizing emergency response agency to access the database through browser 222.

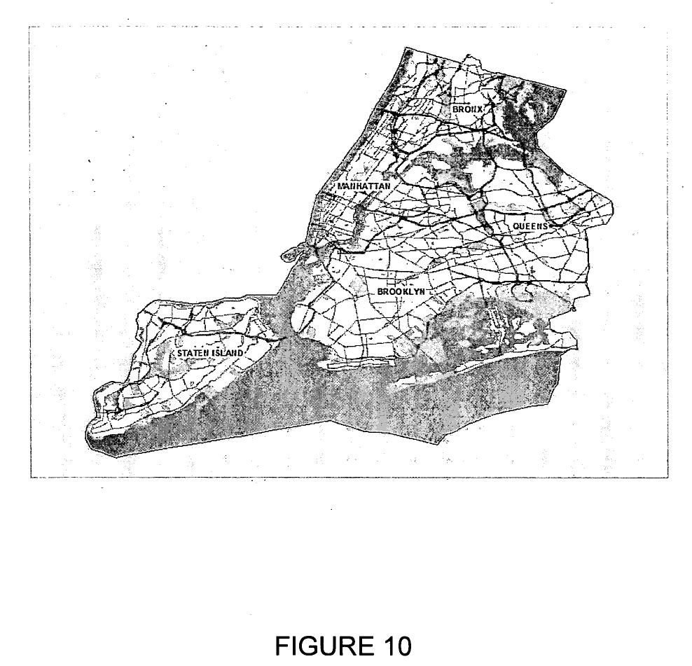

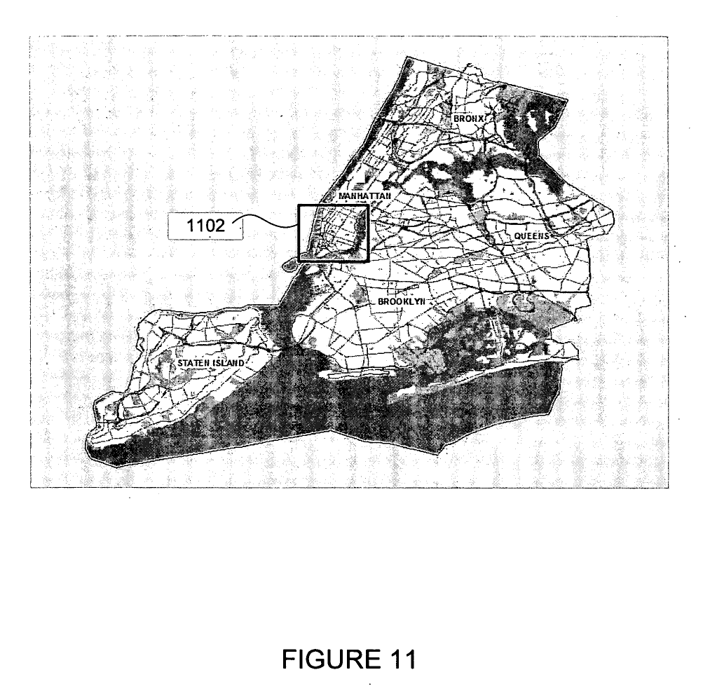

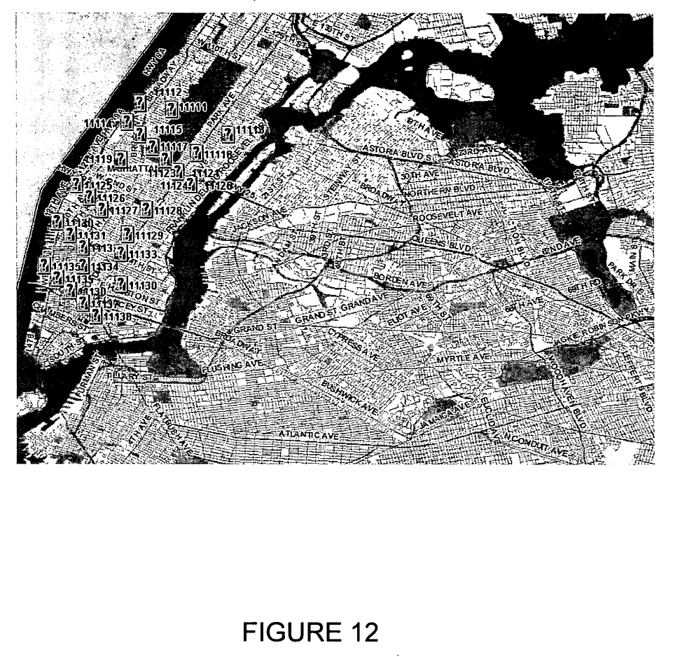

FIGS. 10-11 illustrate the graphical features associated with the map and routing module 406. In these figures, an initial view is shown in FIG. 10 and a defined area or region where the emergency is occurring is identified in FIG. 11 with graphical overlay 1102. The views shown in FIGS. 10 and 11 illustrate an example of the citywide view without any incidents reported. Once the region is defined, the map drills down and displays the location of patients in the defined area as illustrated in FIG. 12 which only shows symbols representing patients that are in an at-risk situation. FIG. 12 shows the same citywide view shown in FIG. 11 except that the selected geographic area 1102 has been designated as an at-risk area. The numbers accompanying the symbols superimposed on the map are the patient identification numbers within the defined particular area. From this point, it is possible to sub-select from the identified patients to decide who needs to be called with a selected broadcast message.

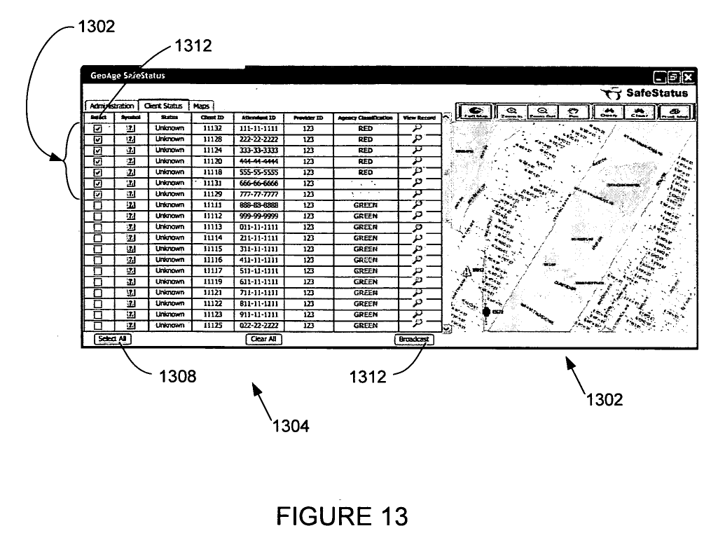

FIG. 13 further illustrates a zoom-in view of the at-risk area shown in FIG. 12. This zoom-in view displays symbols indicating a potential emergency at patient locations within the area of map 1302. This view also displays, at 1304, identification numbers associated with each symbol on the map so that the agency can begin to identify the affected patients. The zoom-in view of FIG. 13 includes a select column 1306 that provides the option of checking individual patient records or clicking the “Select All” button 1308 to choose all of patients. If “Select All” button 1308 is clicked, individual records can be deselected as desired. In this particular example, all red and yellow patients have been selected as indicated at 1310. After the desired records are selected, the user can click the “Broadcast” button 1312. This will initiate the automated calling of all of the selected patients with the then-selected broadcast message.

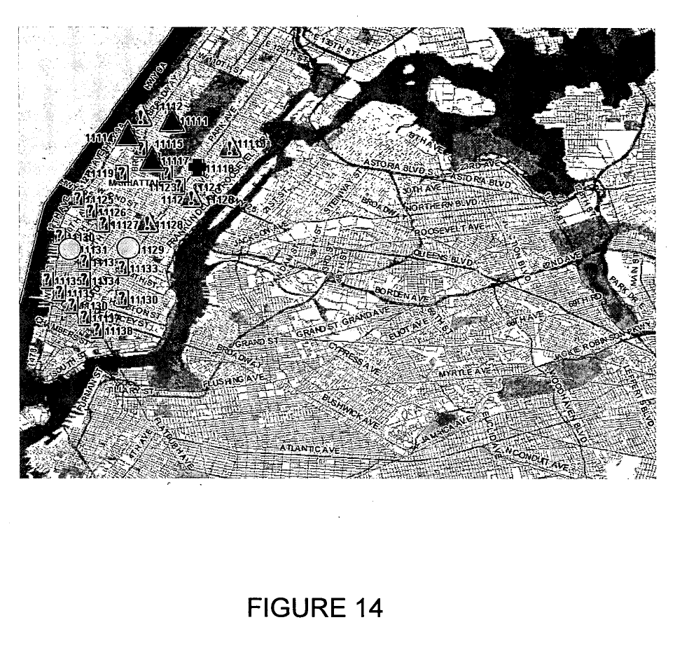

As responses are recorded to the broadcast calls, the map and the report in FIG. 13 will be modified in real time. FIG. 14 illustrates a modified view of the map shown in FIG. 13 based on the partial response from some of the selected patients in response to the broadcast message.

Messages that are answered successfully cause symbols in column 1502 to revert to its original form based on the classification for the patient. Calls that result in an emergency condition are replaced by a new symbol, such as by way of example, a yellow triangle with an enclosed exclamation point. Situations that have not been resolved continue to display a question mark symbol. The map and report views of the mapping function will continue to be updated as the broadcast message receives positive or negative responses.

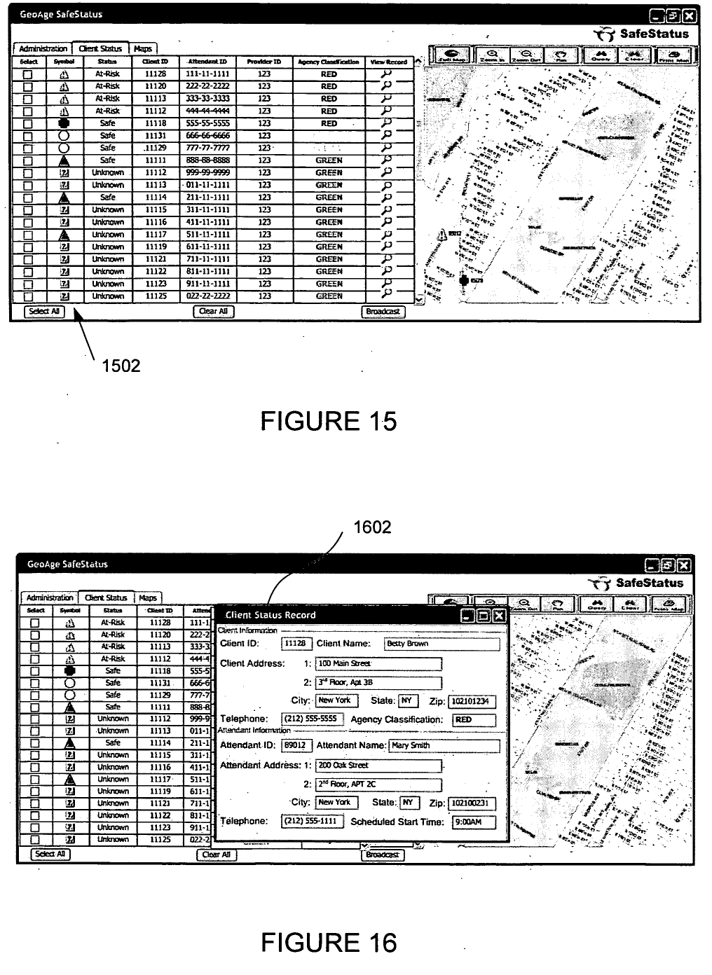

For those patients that have responded negatively, the user can begin to drill down using the report to get further information about the patient so that appropriate resources can be deployed if necessary. FIG. 16 illustrates the drill-down within the report shown at FIG. 15 with patient specific information displayed at 1602.

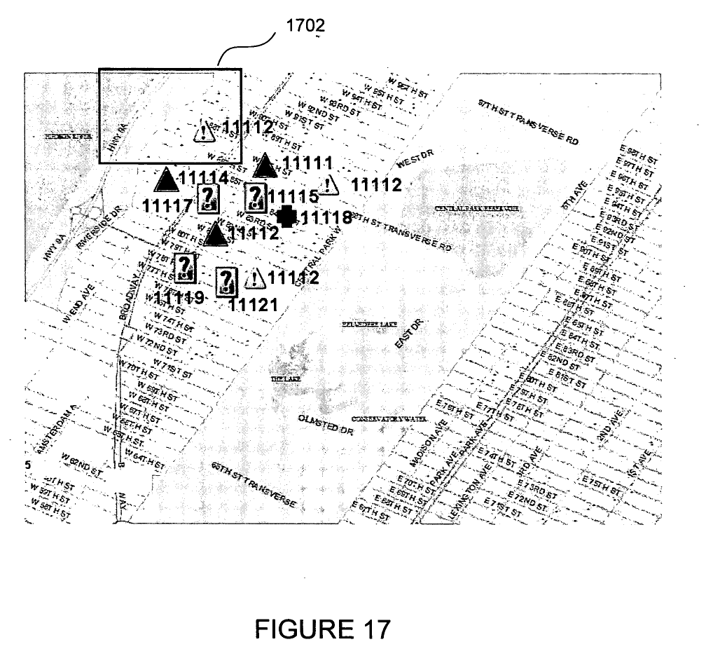

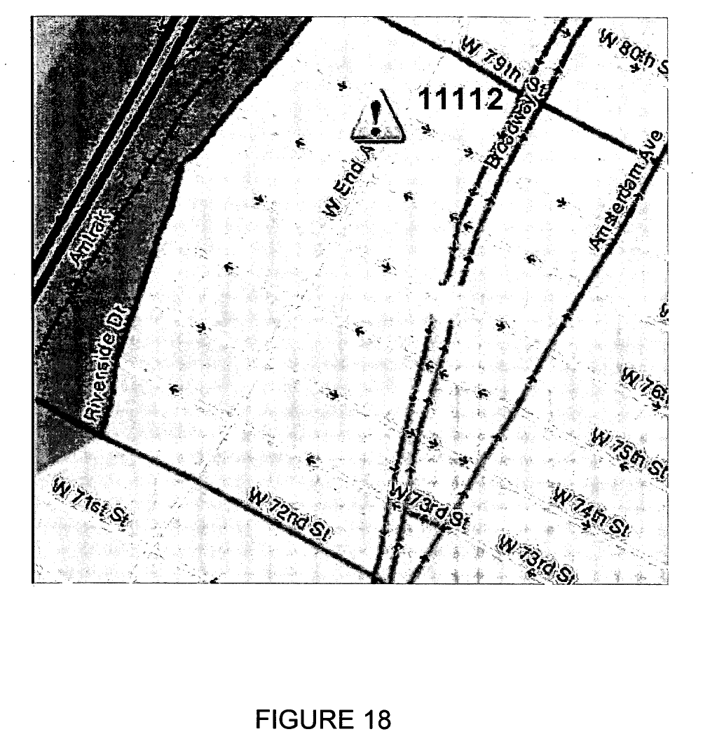

To assist the user with deploying resources, there are further drill-down views into the map of the area. Once an area has been selected, a zoom-in view of the particular area selected will be displayed. The resulting neighborhood view shows individual patients along with streets and intersections. This is particularly useful in directing caregivers to the appropriate address. FIG. 17 shows a zoom-in neighborhood view defined by overlay 1702 while FIG. 18 street level information with patient information superimposed on it. The street view shows the actual intersection at which individual patients reside. This makes it extremely easy for the agency to direct an caregiver to an unfamiliar address. In the example above, patient 11112 is indicated as currently having an emergency status. From this view, emergency responders can access reports containing associated data such as nearest street corner or side of the street where the patient is located in order to quickly resolve the situation.

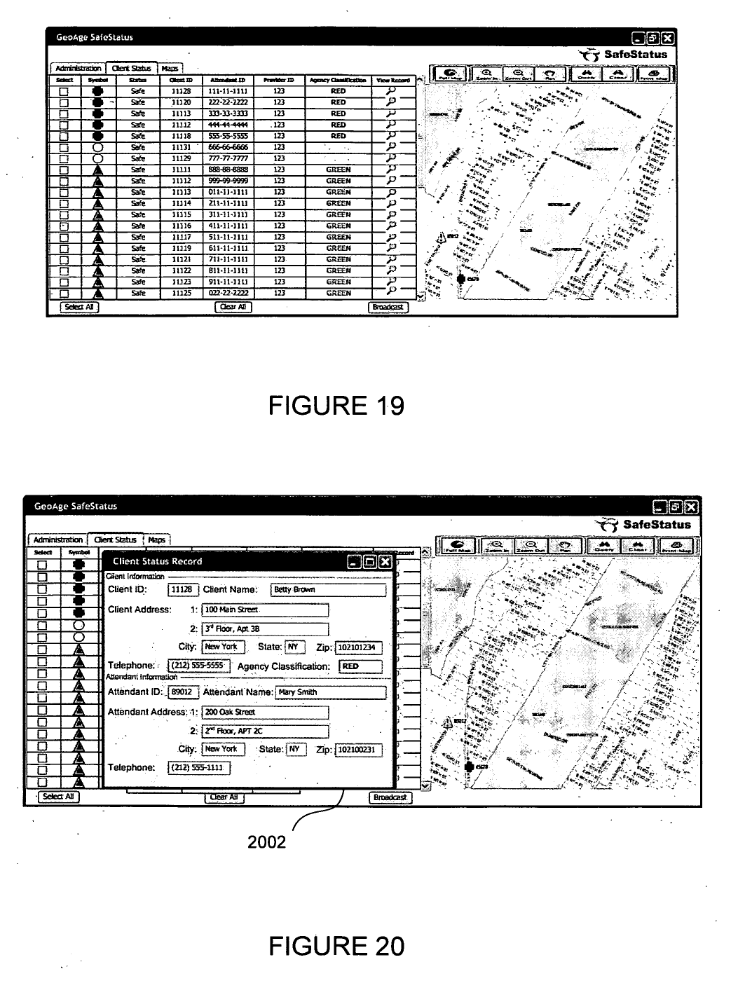

The present invention provides a set of reports to assist emergency responders to react to emergency conditions that affect patients. FIG. 19 shows a sample of a report referred to as a Patient Status Report that can be sorted by any column within it to sort patients by the current status, by caregiver, by client number or by classification. In addition, a detailed record regarding a particular event can be viewed by clicking on the “View Record” icon. A sample of a detail display is shown in FIG. 20 with a detailed status record 2002 selected for a particular patient.

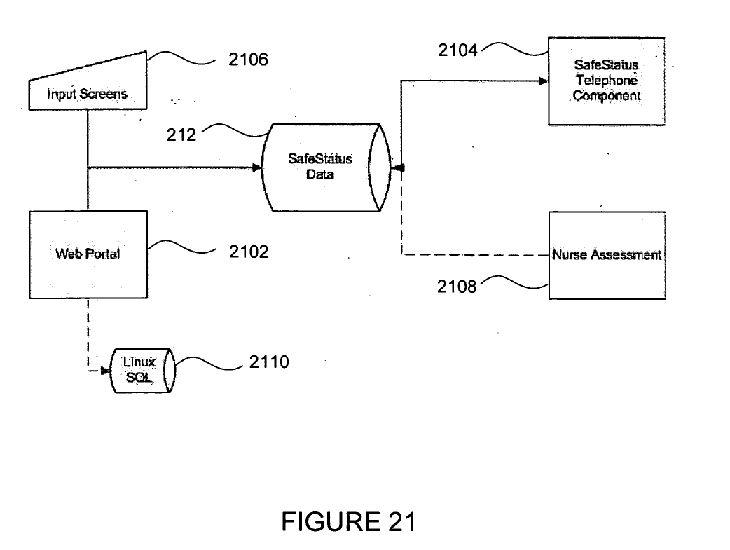

Refer now to FIG. 21 where a representative embodiment of a system for updating database 212 is illustrated. Database 212 is updated by either a web portal application 2102 or a telephone application 2104. The web portal application may be a Linux SQL-enabled Web applications that enable distributed access through a web browser. The telephone application may be the SafeStatus telephone system for broadcasting messages to a selected group of patients and tracking responses to queries. Further, the administrator can authorize data input through a series of input screens 2106. Input screens 2106 may be accessed from system 224 or, using a web browser, a government agency, payer or other approved third party data source. A nurse assessment application 2108 enables the health care provider to classify or change the classification of a patient. Each of these applications contributes to the data set stored in database 212 which collectively comprise a Linux SQL 2110 database.

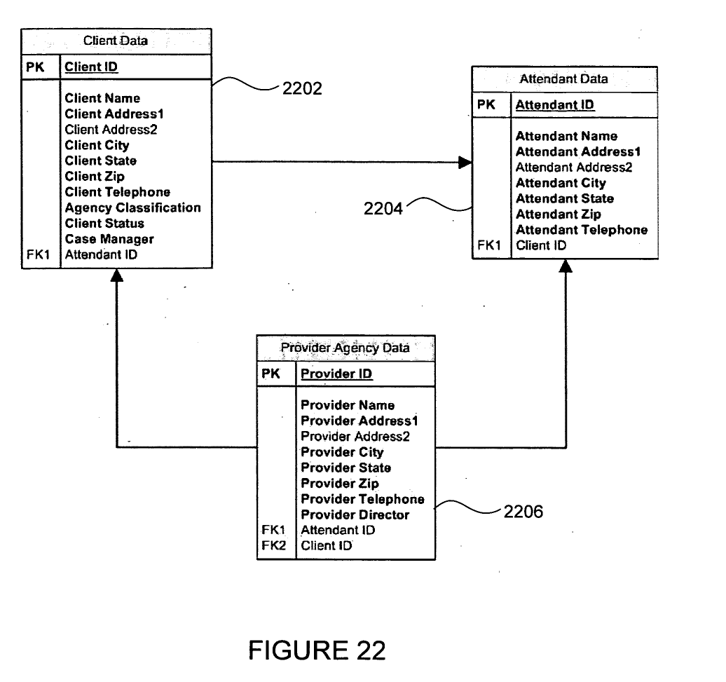

A Table view of a portion of the data in database 212 is displayed in FIG. 22. The three tables include patient data 2202, caregiver data 2204 and provider data 2206 sets. Patient data is the source of the geo-coding that enables the mapping premise to function. The source of the patient data is primarily the provider's own data stores. Table 2 details the data attributes for data contained within this dataset.

TABLE 2

| Field Name | Attributes | Data Source | Comments |
|---|---|---|---|
| Patient ID | Alphanumeric | This value is | Agencies appear to |
| | Length - 11 | assigned by the | use the Patient's |
| | Format: ###-##-#### | provider agency. | Social Security |
| | Required Field | | Number for this value. |
| Patient | Alphanumeric | The patient name is | |
| Name | Length - 50 | provided by the | |
| | Required Field | provider agency. | |
| Patient | Alphanumeric | The patient address | Used for geo-coding. |
| Address1 | Length - 25 | is provided by the | |
| | Required Field | provider agency. | |
| Patient | Alphanumeric | If present, this field | |
| Address2 | Length - 25 | value is provided by | |
| | Optional Field | the provider agency. | |
| Patient City | Alphanumeric | The patient address | Used for geo-coding. |
| | Length - 25 | is provided by the | |
| | Required Field | provider agency. | |
| Patient | Alphanumeric | The patient address | Used for geo-coding. |
| State | Length - 2 | is provided by the | |
| | Required Field | provider agency. | |
| Patient Zip | Numeric | The patient address | Used for geo-coding. |
| | Length - 9 | is provided by the | |
| | Required Field | provider agency. | |
| Patient | Numeric | The telephone | Used to match |
| Telephone | Length - 10 | number is provided | against ANI |
| | Required Field | by the provider | (Caller ID) |
| | | agency. | |
| Emergency | Numeric | The telephone | More than one person |
| Contact | Length - 10 | number(s) is | may be included on |
| Telephone | Required Field | provided by the | the contact list. |
| | | provider agency. | |
| Agency | Alphanumeric | Agency provides | Typical values are |
| Classification | Length - 6 | values for existing | RED, YELLOW, and |
| | Required Field | patients. New | GREEN. |
| | | patient values come | |
| | | from GeoAge Nurse | |
| | | Assessment | |
| | | Application if | |
| | | implemented. | |
| | | Otherwise, values | |
| | | for new patients | |
| | | must be entered by | |
| | | the agency. | |
| Patient | Numeric | The default value is | |
| Status | Length - 2 | 00 which assumes | |
| | Required Field | that all patients are | |
| | Default Value - 00 | safe. The changes | |
| | Values: | in status are the | |
| | 01 - Assigned | result of a call in and | |
| | caregiver has not | entry to the | |
| | arrived within | SafeStatus | |
| | designated time- | telephone system. | |
| | period | | |
| | 02 - Assigned | | |
| | caregiver has arrived | | |
| | 03 - Substitute | | |
| | caregiver has arrived | | |
| | 04 - Patient does not | | |
| | answer door | | |
| | 05 - Patient physical | | |
| | condition has | | |
| | diminished | | |
| | 06 - Patient mental | | |
| | condition has | | |
| | diminished | | |
| | 07 - Patient taken to | | |
| | hospital | | |
| | 08 - Environmental | | |
| | issue | | |
| Case | Alphanumeric | Individual agencies | Determines the |
| Manager | Length - 35 | provide this data | provider's |
| | Required Field | | management |
| | | | employee assigned to |
| | | | oversee a particular |
| | | | patient/caregiver |
| | | | relationship. |

Each record in the patient data table has a corresponding caregiver record that matches up with each patient. This one-to-one relationship establishes which caregiver is supposed to be present at a patient location during an emergency. Table 3 details the data attributes for a record in the caregiver portion of database 212.

TABLE 3

| Field Name | Attributes | Data Source | Comments |
|---|---|---|---|
| Caregiver | Alphanumeric | This value is | Agencies typically |
| ID | Length - 11 | assigned by the | use the |
| | Format: | provider agency. | caregiver's Social |
| | ###-##-#### | | Security Number. |
| | Required Field | | |
| Caregiver | Alphanumeric | The caregiver | |
| Name | Length - 50 | name is provided | |
| | Required Field | by the provider | |
| | | agency. | |
| Caregiver | Alphanumeric | The caregiver | |
| Address1 | Length - 25 | address is | |
| | Required Field | provided by the | |
| | | provider agency. | |
| Caregiver | Alphanumeric | If present, this | |
| Address2 | Length - 25 | field value is | |
| | Optional Field | provided by the | |
| | | provider agency. | |
| Caregiver | Alphanumeric | The caregiver | |
| City | Length - 25 | address is | |
| | Required Field | provided by the | |
| | | provider agency. | |
| Caregiver | Alphanumeric | The caregiver | |
| State | Length - 2 | address is | |
| | Required Field | provided by the | |
| | | provider agency. | |
| Caregiver | Numeric | The caregiver | |
| Zip | Length - 9 | address is | |
| | Required Field | provided by the | |
| | | provider agency. | |
| Caregiver | Numeric | The telephone | |
| Telephone | Length - 10 | number is | |
| | Required Field | provided by the | |
| | | provider agency. | |

Database 212 must be logically partitioned to prevents unauthorized users from looking at restricted data. In order to facilitate the partitioning, data for each provider agency is associated with the patients and caregivers that are served/work for each agency. Table 4 details the provider data attributes.

TABLE 4

| Field Name | Attributes | Data Source |
|---|---|---|
| Provider ID | Alphanumeric | This value is |
| | Length - 11 | assigned by the |
| | Required Field | Human Resources |
| | | Agency (HRA). |
| Provider | Alphanumeric | Already provided. |
| Name | Length - 50 | |
| | Required Field | |
| Provider | Alphanumeric | Already provided. |
| Address1 | Length - 25 | |
| | Required Field | |
| Provider | Alphanumeric | Already provided. |
| Address2 | Length - 25 | |
| | Optional Field | |
| Provider | Alphanumeric | Already provided. |
| City | Length - 25 | |
| | Required Field | |
| Provider | Alphanumeric | Already provided. |
| State | Length - 2 | |
| | Required Field | |
| Provider Zip | Numeric | Already provided. |
| | Length - 9 | |
| | Required Field | |
| Provider | Numeric | Already provided. |
| Telephone | Length - 10 | |
| | Required Field | |
| Provider | Numeric | Already provided. |
| Fax | Length - 10 | |
| | Required Field | |
| Provider | Alphanumeric | Already provided. |
| Director | Length - 35 | |
| | Required Field | |

Setting up and maintaining database 212 requires an initial and an ongoing data gathering process. The initial process requires cooperation with the enrolling governmental agencies so that caregiver and patient data can be collected. The patient data is particularly important as it will be the basis for geo-coding. This geo-coding is the data that facilitates population of the mapping iterations.

Preferably, the governmental agencies or medical entity that referred the patient to the health care provider will to supply the required patient data in an electronic format. When new patients are enrolled, the system needs to be updated. If the referral entity is using the nurse assessment application 2108, a record will automatically be set up upon completion of the initial assessment. Alternatively, the record can be manually set up. When a new caregiver is assigned to a patient or when assignments are changed, the caregiver data for the record must be updated so that the relationship between the caregiver and patient is captured.

Security requirements for database 212 are tied to the separation of data at the governmental agency level. Database 212 is logically secured by private ID, password and encryption. Each administrative employee and caregiver will have a user ID and password that only entitles access to data associated with their particular task.

If governmental agencies set up partnerships between agencies that will be activated in the event of a widespread emergency scenarios, there may be a need for agencies to review data from other agencies with which they are partnered. This can be achieved through the sharing of user ID and password information among agencies during this type of situation. If the system is to be used to view overall data related to all subscribing agency, an overall user ID and password scheme is assigned to allow access to data in database 212.

Although the invention has been described with reference to specific embodiments thereof, these embodiments are merely illustrative, and not restrictive, of the invention. For example, although the system has primarily been described with respect to the architecture of FIGS. 2A and 2B, other such architectures may be used. Various aspects of the invention can be used with different types of field devices, servers or software modules that perform specialized billing or medical functions. Further, various aspects of the invention can be used with a wide variety of digital networks (e.g., Internet, local-area-networks, wi-fi, Blue Tooth) etc.

Any executable code described herein may be implemented in any suitable programming language to implement the routines of the present invention including C, C++, Java, assembly language, or the like. Different programming techniques can be employed such as procedural or object oriented. The routines can operate in an operating system environment or as stand-alone routines occupying all, or a substantial part, of the system processing.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

As used herein the various databases, application software or network components may reside in one or more server computers and more particularly, in the memory of such server computers. As used herein, “memory” for purposes of embodiments of the present invention may be any medium that can contain, store, communicate, propagate, or transport the program for use by or in connection with the instruction execution system, apparatus, system or device. The memory can be, by way of example only but not by limitation, an electronic, magnetic, optical, electromagnetic, infrared, or semiconductor system, apparatus, system, device, propagation medium, or computer memory.

Reference throughout this specification to “one embodiment,” “an embodiment,” or “a specific embodiment” means that a particular feature, structure, or characteristic described in connection with the embodiment is included in at least one embodiment of the present invention and not necessarily in all embodiments. Thus, respective appearances of the phrases “in one embodiment,” “in an embodiment,” or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer and, in general, the functions of the present invention can be achieved by any means as is known in the art. Distributed, or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

1. A system for delivering health care services to home bound patient and monitoring caregivers providing medical services at remote locations comprising:
a server computer having patient specific information including the location, home health care plan for said patient and means for monitoring the caregiver while the caregiver is providing medical service to the patient;
a field information recording device having a GPS receiver for indicating the location of the caregiver and for providing the caregiver information regarding the patient; and
a communication system coupling said server computer to said field information device so that caregivers may access patient information maintained on said server and so that the server may receive an indication of the caregiver's location.

2. The system of claim 1 further comprising:
a payment processing module, resident on the server, for determining the appropriate billing amount in view of the time caregiver is present at the location of the home bound patient and for the services provided by the caregiver, the processing module including means for communicating the billing information to the payer on a periodic basis.

3. The system of claim 1 further comprising:
a database containing patient location information and the type of care required by the patient;
a route planning module, coupled to the database, for planning the route for each caregiver so that each home bound patient receives care from a caregiver having the appropriate skills and knowledge for providing the necessary care required by the patient and the caregiver is provided with an optimized route from one home bound patient to the next home bound patient.

4. A method of improving home health care, the method comprising:
generating a route for a plurality of caregivers to provide health care service to home bound patients;
assigning each caregiver to patients having common needs and that are geographically proximate to each other;
recording the arrival of each caregiver at each patient's home;
monitoring the services provided by each caregiver to each patient;
determining whether the services provided are consistent with the patient plan and, if not consistent, obtaining advanced approval for providing such services to the payer so that bills for such services are not subsequently declined.

5. A method of improving home health care, the method comprising:
routing a caregiver to a homebound patient;
assigning the caregiver a plurality of patient specific tasks;
recording the arrival of each caregiver at each patient's home;
monitoring the services provided by each caregiver to each patient; and
transferring a record of the services to a payer.

6. The method of claim 5 further comprising:
providing a field device to the caregiver; and
updating the information in the field device with patient specific information and with route specific information.

7. The method of claim 5 wherein said transferring step occurs on a daily basis.

8. The method of claim 5 wherein said transferring step occurs at the conclusion of each patient visit.

9. The method of claim 5 wherein said assigning step occurs on a daily basis.

10. The method of claim 5 wherein said monitoring step includes transferring a summary of each caregiver's activity to a server computer and providing the summary to a medically qualified administrator for review in real time.

11. The method of claim 5 wherein, in response to the receipt of an indication form the payer that the caregiver's services are non-reimbursable, changing the plurality of assigned tasks for the next visit by the caregiver.

12. The method of claim 5 further including the step of providing the patient a telephonic notice of the caregiver's arrival.

13. The method of claim 5 further including the step of providing the patient with a confirmed appointment with their physician in response to a caregiver's diagnosis.

14. The method of claim 5 further including the steps of monitoring hospital admissions and adjusting the caregiver's schedule if the patient is admitted to the hospital.

15. The method of claim 5 further including the steps of providing emergency agencies information regarding each patient in a region affected by an emergency condition.

16. The method of claim 15 further including the steps of providing emergency personnel with the patient's name, location and medical condition to facilitate their care in the event of a disaster or emergency condition.

17. A system for tracking patients who receive home health care comprising:
a field device for recording the status of said patient by an caregiver;
a database containing patient-geo-coded information accessible by said field device;
a server communicatively coupled to said field device and to said database; said server executing a plurality of software modules for accessing said geo-code information and generating a routing map for said caregiver and for determining the medical necessity of a treatment to be provided by said caregiver; and
means for automatically determining whether said treatment will be compensated by a payer.

18. The system of claim 17 further comprising means for identifying at risk patients in the event of an emergency.

19. The system of claim 18 further comprising means for broadcasting a message to said at risk patients, said message comprising at least one query.

20. The system of claim 19 further comprising means for updating a map in response to said query.

21. The system of claim 17 further comprising means for generating an audit trail for each caregiver and patient.

22. The system of claim 17 further comprising means for routing said emergency responders to said patient.

23. The system of claim 17 further comprising means for determining the status of each patient in said database.

24. A method of improving home health care in the event of an emergency, the method comprising:
generating a route for a plurality of emergency responders to a patient who has been identified as at risk; provide health care service to home bound patients;
assigning an emergency responder that is geographically proximate to said patient; and
recording the arrival of said emergency responder at each patient's home.

25. A system for monitoring the status of homebound patients comprising:
a computer system having location, assignment and risk assessment information for each patient being monitored;
a field device for indicating the commencement time and date of a visit by a caregiver and for receiving said information from said computer system; and
a communication system coupling said computer system to said field device so that said computer system may receive an indication of the commencement of the visit and an indication of the condition of said patient at the conclusion of said visit.

26. The system of claim 25 further comprising a GIS geocoding module that matches address information to specific geographic locations; said module adapted to presenting traveling instructions to said caregiver on a visual display.

27. The system of claim 25 further comprising:
a database containing said location, assignment and risk assessment information and a history of the care given to said patient; and
a reporting module, coupled to the database, for trend analysis, performance monitoring and caregiver deployment.

28. The system of claim 25 wherein said field device comprises a cellular telephone.

29. The system of claim 25 wherein said field device comprises a communication device having a GPS receiver.
